(19) United States
(12) Patent Application Publication
(10) Pub. No.: US 2011/0043545 A1
(43) Pub. Date: Feb. 24, 2011

(54) LED DISPLAY SYSTEM AND DATA-TRANSMISSION CONTROL METHOD OF SAME

(75) Inventor: CHI-FENG HUANG, Hsinchu (TW)

Correspondence Address: WPAT, PC;INTELLECTUAL PROPERTY ATTORNEYS, 7225 BEVERLY ST., ANNANDALE, VA, 22003, US

(73) Assignee: ENE TECHNOLOGY INC., Hsinchu (TW)

(21) Appl. No.: 12/858,731

(22) Filed: Aug. 18, 2010

(30) Foreign Application Priority Data
Aug. 20, 2009 (TW) 098128079

(51) Int. Cl. G09G 5/10; G09G 3/32

(52) U.S. Cl. 345/690; 345/82

(57) ABSTRACT

A LED display system includes a display controller includes an output/input port; a plurality of driving circuits coupled in series, wherein a first one of the driving circuits is coupled to the output/input port; and a plurality of LED sets respectively coupled to the plurality of driving circuits. A plurality of image data, outputted from the display controller, are shifted to the plurality of driving circuits, respectively, in a first direction through the first one of the driving circuits when the display controller is in a displaying mode; and a plurality of status data, respectively generated by the plurality of driving circuits, are shifted to the display controller in a second direction through the first one of the driving circuits when the display controller is in a detecting mode.

### FIELD OF THE INVENTION

The present invention relates to a LED (Light Emitting Diode) display system, and more particularly to a driving circuit arranged in a LED display system. The present invention also relates to a data-transmission control method of a LED display system for use with a driving circuit.

### BACKGROUND OF THE INVENTION

A LED display system is commonly applied to daily lives both indoors and outdoors due to enhanced power and illuminance of devices as well as mass production capability in factories. An example of the outdoor application of the LED display system is shown in FIG. 1, which is a diagram schematically depicting a display 110 of a LED display system disposed on a wall of a building 120. A similar LED display system may also be disposed on a wall in an indoor stadium as an example of the indoor application. The LED display system can be used for, for example, playing commercials or showing real-time information, e.g. live video of sports game.

FIG. 2 is a block diagram illustrating a LED display system with 6×2 resolution. There are twelve driving circuits 11˜16 and 21˜26 and twelve LED sets 211˜216 and 221˜226 included in a display 210, wherein the six driving circuits 11˜16 are coupled in series and the six LED sets 211˜216 are arranged in a first row; and the six driving circuits 21˜26 are coupled in series and the six LED sets 221˜226 are arranged in a second row. The color and brightness of the LED sets 211˜216 and 221˜226 are controlled by the driving circuits 11˜16 and 21˜26, respectively.

Moreover, the LED display system further includes a display controller 200, which includes a first output port (D1), a first input port (R1), a second output port (D2), and a second input port (R2). The first output port (D1) is connected to the driving circuit 11 and the first input port (R1) is connected to the driving circuit 16 so that a loop is constructed through the display controller 200 and the six driving circuits 11˜16 in the first row. Similarly, the second output port (D2) is connected to the driving circuit 21 and the second input port (R2) is connected to the driving circuit 26 so that another loop is constructed through the display controller 200 and the six driving circuits 21˜26 in the second row.

It is understood that a LED display system may have resolution up to 1024×768 , and accordingly there would be 768 loops in the LED display system and in each of the loop there would be 1024 driving circuits coupled in series. Each of the LED sets 11˜16 and 21˜26 can be constructed by a single pixel or multiple pixels. A specified image can be shown on the display 210 under the cooperation of the display controller 200 and the driving circuits 11˜16 and 21˜26.

FIG. 3A and FIG. 3B are functional block diagrams illustrating one of the circuit loops included in a LED display system according to prior art. The first output port (D1) of the display controller 300 includes a data-output terminal (do) and a clock-output terminal (cko), wherein an image data is outputted from the data-output terminal (do) and a clock signal is outputted from the clock-output terminal (cko). Since there are six driving circuits 310˜360 coupled in series in the loop, a displaying cycle is defined as the duration that six image data are sequentially outputted from the data-output terminal (do) to the six driving circuits 310˜360 for controlling the six LED sets 312˜362, respectively.

The display controller can be operated either in a displaying mode, as illustrated in FIG. 3A, or in a detecting mode, as illustrated in FIG. 3B. When the display controller 300 is in the displaying mode, six image data are sequentially transmitted to the six driving circuits 310˜360 from the display controller 300 through the data-output terminal (do) as described below. A first image data is transmitted to the sixth driving circuit 360 after being outputted from the display controller 300, and then shifted to the fifth driving circuit 350. Meanwhile, a second image data is transmitted to the sixth driving circuit 360 from the display controller 300. While the first image data is shifted to the fourth driving circuit 340, the second image data is shifted to the fifth driving circuit 350. Likewise, a third image data is transmitted to the sixth driving circuit 360 from the display controller 300, and then shifted to the fifth driving circuit 350, while the first image data is shifted to the third driving circuit 330, and the second image data is shifted to the fourth driving circuit 340; the fourth image data is transmitted to the sixth driving circuit 360 from the display controller 300, and the shifted to the fifth driving circuit 350, while the first image data is shifted to the second driving circuit 320, the second image data is shifted to the third driving circuit 330, and the third image data is shifted to the fourth driving circuit 340; the fifth image data is transmitted to the sixth driving circuit 360 from the display controller 300, and then shifted to the fifth driving circuit 350, while the first image data is shifted to the first driving circuit 310, the second image data is shifted to the second driving circuit 320, the third image data is shifted to the third driving circuit 330, and the fourth image data is shifted to the fourth driving circuit 340; and meanwhile the sixth image data is transmitted to the sixth driving circuit 360 from the display controller 300.

Consequently, the color and brightness of the LED set 312 can be controlled by the first control circuit 310 according to the first image data; the color and brightness of the LED set 322 can be controlled by the second control circuit 320 according to the second image data; the color and brightness of the LED set 332 can be controlled by the third control circuit 330 according to the third image data; the color and brightness of the LED set 342 can be controlled by the fourth control circuit 340 according to the fourth image data; the color and brightness of the LED set 352 can be controlled by the fifth control circuit 350 according to the fifth image data; and the color and brightness of the LED set 362 can be controlled by the sixth control circuit 360 according to the sixth image data.

Another display cycle is then begin and the above process is repeated to sequentially output another six image data from the display controller 300 through the data-output terminal (do) and have the six image data shifted to respective the six driving circuits 310˜360.

The display controller 300 is switched to the detecting mode if there is no further image data outputted from the display controller 300. In the detecting mode, each of the driving circuits 310˜360 and its corresponding LED set are detected, and a corresponding status data is generated based on the detecting results. The status data may include LED status data, driving-circuit temperature data, and driving-circuit error data, etc.

As shown in FIG. 3B, the first input port (R1) of the display controller 300 includes a data-input terminal (ri) and a clock-input terminal (cki); wherein the data-input terminal (ri) is used for receiving a series of the status data which are generated by the driving circuits 310˜360, and the clock-input terminal (cki) is used for receiving the clock signal transmitted through the driving circuits 310˜360. As mentioned above, a first status data is generated by the first driving circuit 310; a second status data is generated by the second driving circuit 320; a third status data is generated by the third driving circuit 330; a fourth status data is generated by the fourth driving circuit 340; a fifth status data is generated by the fifth driving circuit 350; and a sixth status data is generated by the sixth driving circuit 360 while the display controller 300 is entering the detecting mode. The six status data are then sequentially shifted to the data-input terminal (ri) through the six driving circuits 310˜360. Since the process of transmitting the six status data to the data-input terminal (ri) through the six driving circuits 310˜360 is similar to the process of transmitting the six image data from the data-output terminal (do) through the six driving circuits 310˜360, it is not to be redundantly described in detail herein.

Referring to FIG. 3B, a detecting cycle is defined as the duration that the six status data are generated by the six driving circuits 310˜360 and sequentially transmitted to the data-input terminal (ri) through the six driving circuits 310˜360. According to the six status data, the display controller 300 can realize the operation states of the six LED sets 312˜362 and the six driving circuits 310˜360.

FIG. 4 is a block diagram illustrating one of the driving circuits used in the prior art of FIG. 3A and FIG. 3B. The prior-art driving circuit 400, for controlling a LED set 440, includes a shift register 410, a switching-control unit 402, a detection-control unit 404, a clock buffer 470, and a mode-detecting unit 490. The switching-control unit 402 includes a display register 420 and a driving-current generating circuit 430. The detection-control unit 404 includes a status register 460 and a status-detecting circuit 450. The LED set 440 includes a single LED or a plurality of LEDs emitting different colors of light, e.g. red, green, and blue light.

The driving circuit 400 further includes a data-input terminal (XSDI), a clock-input terminal (XCKI), a data-output terminal (XSDO), and a clock-output terminal (XCKO). The clock-input terminal (XCKI) is used for receiving the clock signal, and the clock signal is then transmitted to the clock-output terminal (XCKO) via the clock buffer 470. The shift register 410, connected to the data-input terminal (XSDI) and the detection-control unit 404, is used for temporarily storing the image data or the status data, depending on the operation mode; wherein the image data is received from the data-input terminal (XSDI), and the status data is received from the status register 460 or from preceding stage of driving circuit through the data-input terminal (XSDI). Afterwards, the image data stored in the shift register 410 is transmitted to the data-output terminal (XSDO) in the displaying mode; while the status data stored in the shift register 410 is transmitted to the data-output terminal (XSDO) in the detecting mode.

When the mode-detecting unit 490 detects that the display controller is in the displaying mode, the switching-control unit 402 is enabled by the mode-detecting unit 490 so that what the shift register 410 receives is the image data. The image data is transmitted to the display register 420, and in response, a corresponding driving current is generated by the driving current generating circuit 430, and outputted to the LED set 440 to control the color and brightness of the LED set 440.

On the other hand, when the mode-detecting unit 490 detects that the display controller is in the detecting mode, the detection-control unit 404 is enabled by the mode-detecting unit 490 so that what is received by the shift register 410 is the status data. The status data is generated by the status-detecting circuit 450 in response to open-circuit and/or short-circuit detection of the LED set 440, temperature and/or error detection of the driving circuit 400, etc. The status data is stored in the status register 460 and then transmitted to the shift register 410. According to the status data transmitted to the display controller through the data-output terminal (XSDO) of the driving circuit 400, the operation conditions of the LED set 440 and the driving circuit 400 can be realized by the display controller.

When the above-mentioned LED display system is applied to a very large scale of display, for example disposed on a wall of a building or a stadium, the amount of driving circuits would be huge. If there are over 1000 driving circuits in a single loop and the distance between each two driving circuits is about 10 to 20 cm, the transmitting line, e.g. a cable, from the last driving circuit (i.e. the driving circuit farthest from the display controller) to the input port of the display controller would be as long as 100 to 200 m.

Since each of the status data need be shifted to the last driving circuit and transmitted through the transmitting cable before reaching the input port of the display controller, the signal decay would be serious.

### SUMMARY OF THE INVENTION

Therefore, the present invention provides a LED display system, in which no long cable is required for transmitting status data.

The present invention provides a LED display system, which includes a display controller comprising an output/input port; a plurality of driving circuits coupled in series, wherein a first one of the driving circuits is coupled to the output/input port; and a plurality of LED sets respectively coupled to the plurality of driving circuits. A plurality of image data, outputted from the display controller, are shifted to the plurality of driving circuits, respectively, in a first direction through the first one of the driving circuits when the display controller is in a displaying mode; and a plurality of status data, respectively generated by the plurality of driving circuits, are shifted to the display controller in a second direction through the first one of the driving circuits when the display controller is in a detecting mode.

The present invention also provides a data-transmission control method of a LED display system. The LED display system includes a display controller, a plurality of LED sets and a plurality of driving circuits coupled in series, respectively coupled to the plurality of LED sets, and further coupled to the display controller via a first one of the driving circuits. The data-transmission control method includes steps of: outputting a plurality of image data from the display controller and respectively shifting the plurality of image data to the plurality of driving circuits in a first direction through the first one of the driving circuits when the display controller is in a displaying mode; and respectively outputting a plurality of status data from the plurality of driving circuits and shifting the plurality of status data to the display controller in a second direction through the first one of the driving circuits when the display controller is in a detecting mode.

The present invention further provides a driving circuit for use in a LED display system to drive a LED set coupled thereto. The driving circuit includes a data-input/output terminal; a first switch circuit coupled to the data-input/output terminal; a shift register coupled to the first switch circuit; a second switch circuit coupled to the shift register; a data-output/input terminal connected to the second switch circuit; a switching-control unit, coupled to the shift register, from which a driving current is outputted to the LED set according to an image data temporarily stored in the shift register when the display controller is in a displaying mode; a detection-control unit, coupled to the shift register, from which a status data is outputted to be temporarily stored in the shift register when the display controller is in a detecting mode; and a mode-detecting unit coupled to the first switch circuit and the second switch circuit for determining an operation mode of the display controller to be the displaying mode or the detecting mode, and controlling the switching-control unit, the detection-control unit, the first switch circuit and the second switch circuit based on the operation mode. When the display controller is in the displaying mode, the first switch circuit and the second circuit are controlled to transmit the image data through the first switch circuit and then the shift register, and when the display controller is in the connecting mode, the first switch circuit and the second circuit are controlled to transmit the status data through the shift register and then the first switch circuit.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic diagram illustrating a very large scale of LED display system;

FIG. 2 is a functional block diagram schematically illustrating a LED display system;

FIG. 3A and FIG. 3B are functional block diagrams schematically illustrating a single loop of a LED display system according to prior art;

FIG. 4 is a functional block diagram of a driving circuit according to prior art;

FIG. 5 is a functional block diagram schematically illustrating a LED display system according to an embodiment of the present invention;

FIG. 6A and FIG. 6B are functional block diagrams schematically illustrating a single loop of a LED display system according to an embodiment of the present invention; and

FIG. 7 is a functional block diagram of a driving circuit according to an embodiment of the present invention.

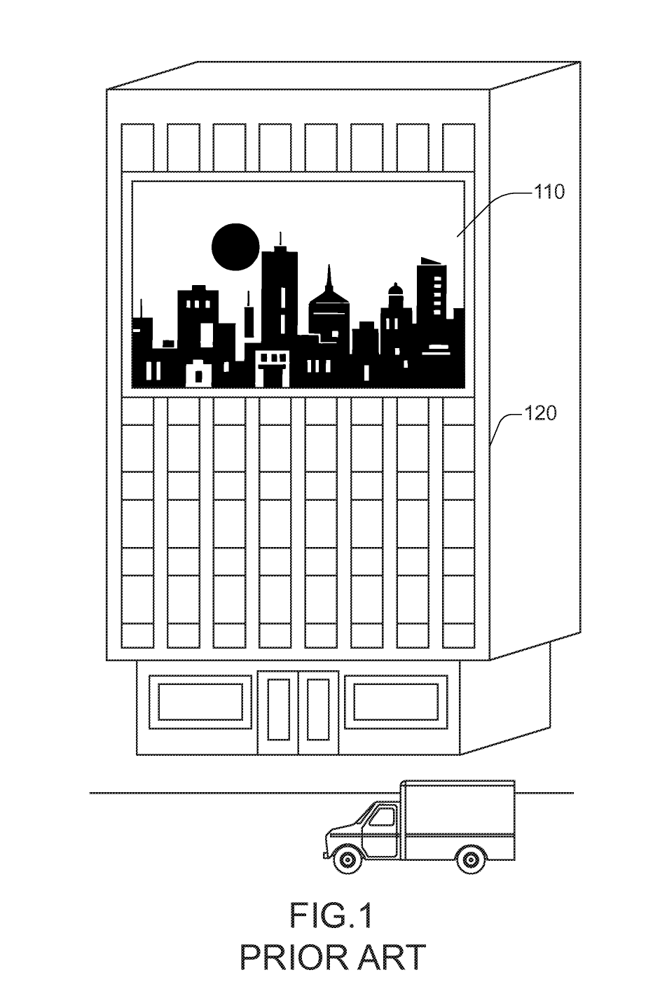

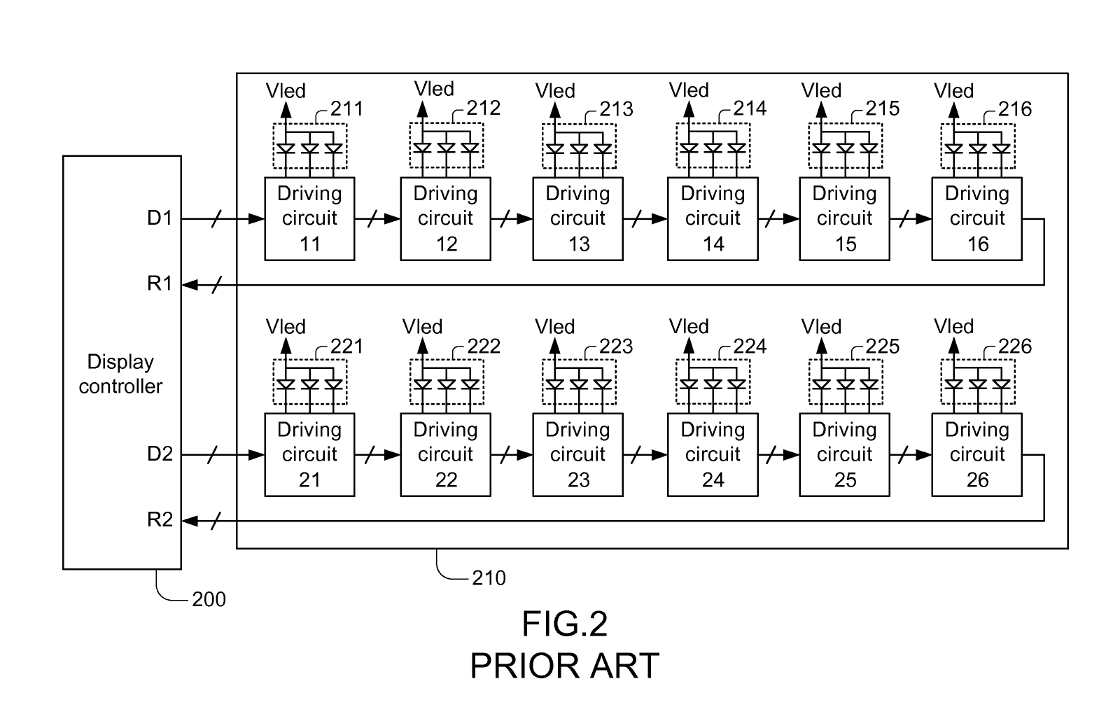

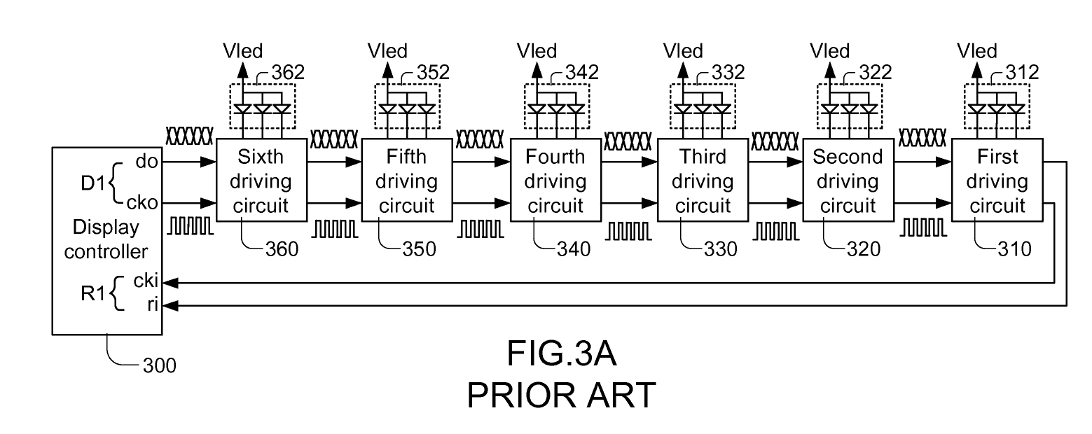

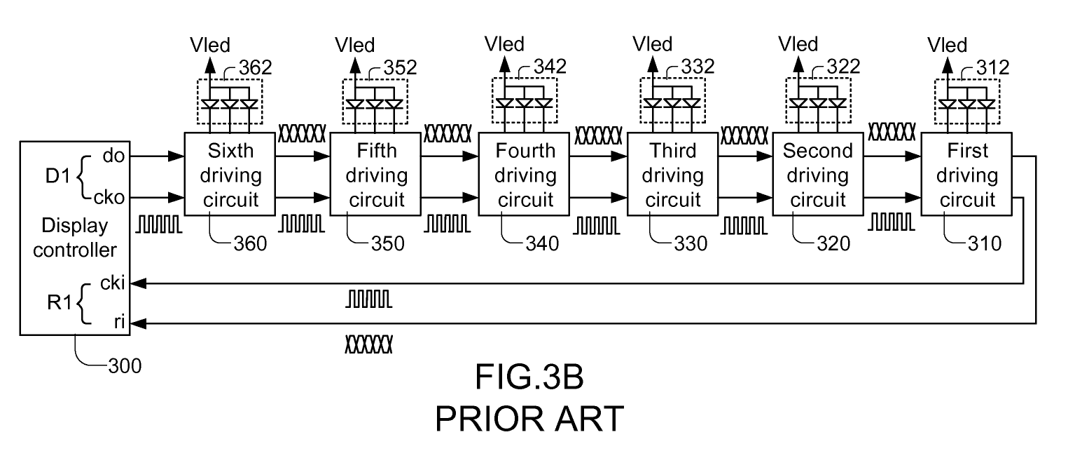

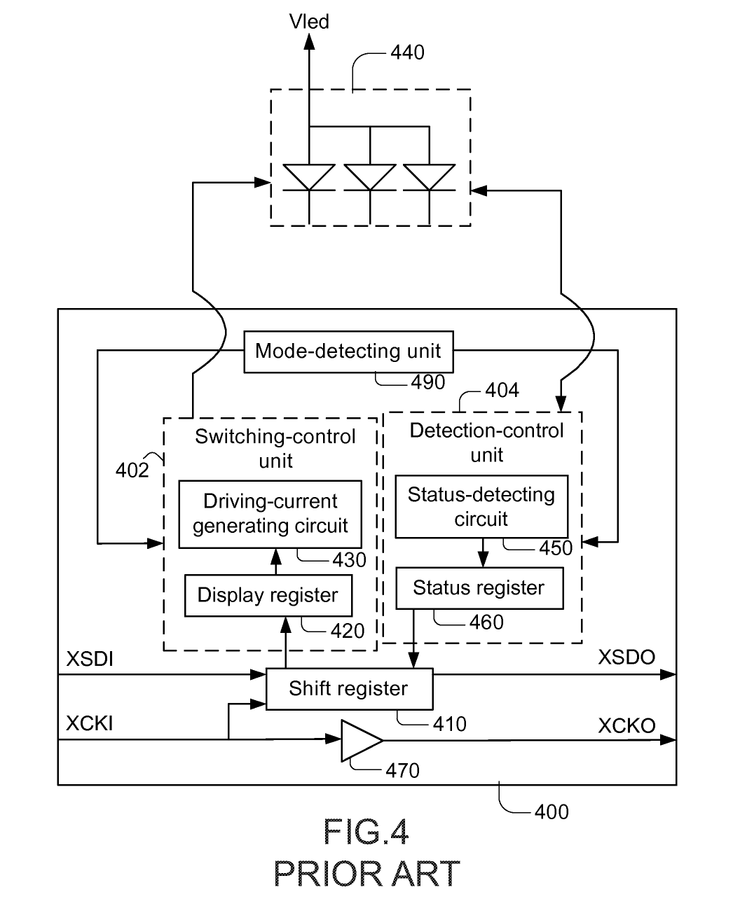

### DETAILED DESCRIPTION OF PREFERRED EMBODIMENTS

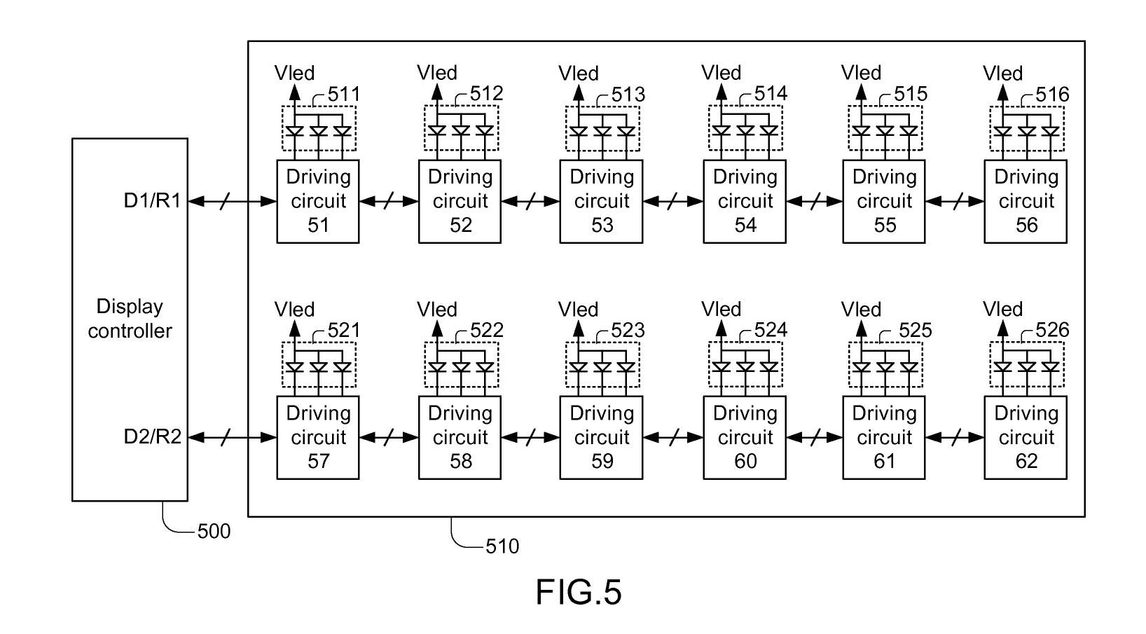

FIG. 5 is a block diagram illustrating a LED display system of the present invention. Because a definition of 6×2 is exemplified in FIG. 5, accordingly there are twelve driving circuits 51˜62 and twelve LED sets 511˜516 and 521˜526 are shown on a display 510, where the six driving circuits 51˜56 coupled in series and the six LED sets 511˜516 are arranged in a first row; and the six driving circuits 57˜62 coupled in series and the six LED sets 521˜526 are arranged in a second row. The color and brightness of the LED sets 511˜516 and 521˜526 are controlled by the driving circuits 51˜62, respectively. Moreover, the display controller 500 includes a first output/input port (D1/R1) and a second output/input port (D2/R2). The first output/input port (D1/R1) is connected to the driving circuit 51 and the second output/input port (D2/R2) is connected to the driving circuit 57.

It is understood that the LED display system illustrated in FIG. 5 is only an example. As mentioned above, if the definition of the LED display system of the present invention is 1024×768, accordingly there are 768 output/input ports in the display controller and each of the output/input port is connected in series to 1024 driving circuits which are arranged in a row. Moreover, the LED set can be structured by a single pixel or multiple pixels. A specified image can be shown on the display 510 under the cooperation of the display controller 500 and the driving circuits 51˜62.

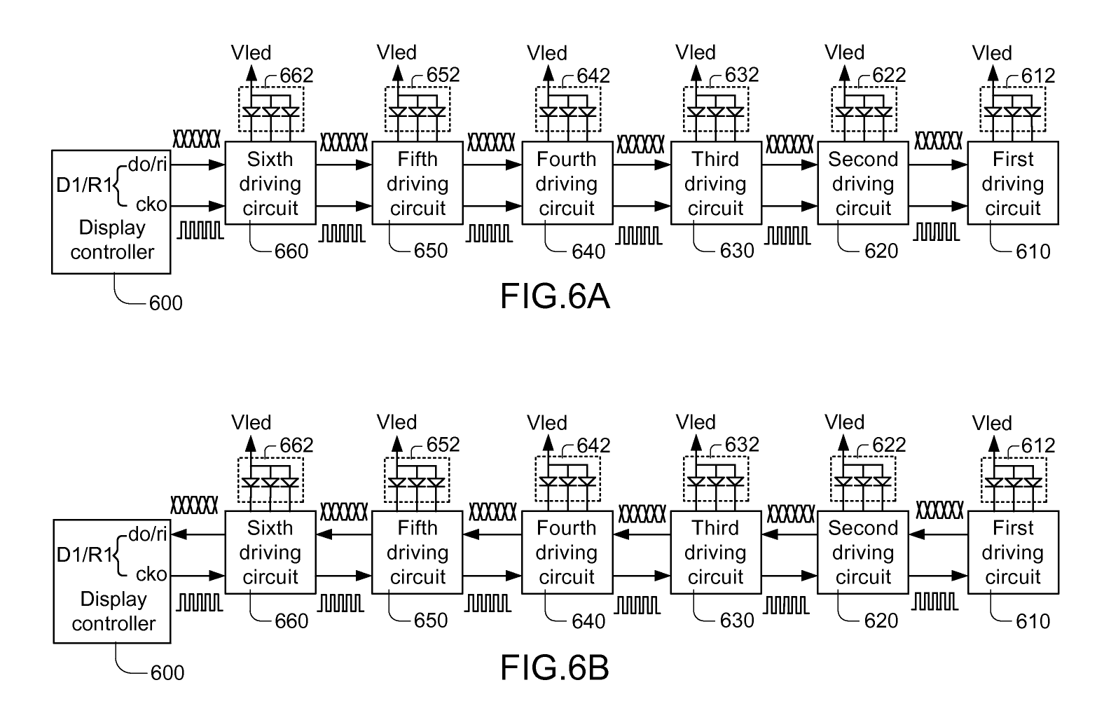

The display controller can be operated either in a displaying mode, as illustrated in FIG. 6A, or in a detecting mode, as illustrated in FIG. 6B. When the display controller 600 is in the displaying mode, six image data are sequentially transmitted to the six driving circuits 610˜660 from the display controller 600 through a data output/input terminal (do/ri) of the first output/input port (D1/R1), as described below. A first image data is transmitted to the sixth driving circuit 660 after being outputted from the display controller 600, and then shifted to the fifth driving circuit 650. Meanwhile, a second image data is transmitted to the sixth driving circuit 660 from the display controller 600. While the first image data is shifted to the fourth driving circuit 640, the second image data is shifted to the fifth driving circuit 650. Likewise, a third image data is transmitted to the sixth driving circuit 660 from the display controller 600, and then shifted to the fifth driving circuit 350, while the first image data is shifted to the third driving circuit 630, and the second image data is shifted to the fourth driving circuit 640; the fourth image data is transmitted to the sixth driving circuit 660 from the display controller 600, and the shifted to the fifth driving circuit 650, while the first image data is shifted to the second driving circuit 620, the second image data is shifted to the third driving circuit 630, and the third image data is shifted to the fourth driving circuit 640; the fifth image data is transmitted to the sixth driving circuit 660 from the display controller 600, and then shifted to the fifth driving circuit 650, while the first image data is shifted to the first driving circuit 610, the second image data is shifted to the second driving circuit 620, the third image data is shifted to the third driving circuit 630, and the fourth image data is shifted to the fourth driving circuit 640; and meanwhile the sixth image data is transmitted to the sixth driving circuit 660 from the display controller 600. The transmission of the image data is based on the clock signal.

Consequently, the color and brightness of the LED set 612 can be controlled by the first control circuit 610 according to the first image data; the color and brightness of the LED set 622 can be controlled by the second control circuit 620 according to the second image data; the color and brightness of the LED set 632 can be controlled by the third control circuit 630 according to the third image data; the color and brightness of the LED set 642 can be controlled by the fourth control circuit 640 according to the fourth image data; the color and brightness of the LED set 652 can be controlled by the fifth control circuit 650 according to the fifth image data; and the color and brightness of the LED set 662 can be controlled by the sixth control circuit 660 according to the sixth image data.

Another display cycle is then begin and the above process is repeated to sequentially output another six image data from the display controller 600 through the data-output terminal (do) and have the six image data shifted to respective the six driving circuits 610˜660.

The display controller 600 is switched to the detecting mode if there is no further image data outputted from the display controller 600. In the detecting mode, each of the driving circuits 610˜660 and its corresponding LED set are detected, and a corresponding status data is generated based on the detecting results. The status data may include LED status data, driving-circuit temperature data, and driving-circuit error data, etc.

Then refer to FIG. 6B, in which the transmission of status data in the detecting mode is illustrated. In the detecting mode, the first driving circuit 610 generates a first status data; the second driving circuit 620 generates a second status data; the third driving circuit 630 generates a third status data; the fourth driving circuit 640 generates a fourth status data; the fifth driving circuit 650 generates a fifth status data; and the sixth driving circuit 610 generates a sixth status data. The six status data are then sequentially shifted to the data output/input terminal (do/ri) through the driving circuits 610˜660 to be received by the display controller 600. That is, when the sixth status data is transmitted to the display controller 600, the fifth status data is shifted to the sixth driving circuit 660. Meanwhile, the fourth status data is shifted to the fifth driving circuit 650, the third status data is shifted to the fourth driving circuit 640, the second status data is shifted to the third driving circuit 630 and the first status data is shifted to the second driving circuit 620. Likewise, when the fifth status data is transmitted to the display controller 600, the fourth status data is shifted to the sixth driving circuit 660, the third status data is shifted to the fifth driving circuit 650, the second status data is shifted to the fourth driving circuit 640 and the first status data is shifted to the third driving circuit 630. When the fourth status data is transmitted to the display controller 600, the third status data is shifted to the sixth driving circuit 660, the second status data is shifted to the fifth driving circuit 650 and the first status data is shifted to the fourth driving circuit 640. When the third status data is transmitted to the display controller 600, the second status data is shifted to the sixth driving circuit 660, and the first status data is shifted to the fifth driving circuit 650. When the second status data is transmitted to the display controller 600, the first status data is shifted to the sixth driving circuit 660. Finally, the first status data is transmitted to the display controller 600. The transmission of the status data is based on the clock signal.

In brief, the display controller 600 receives six status data in series in a detecting cycle, thereby realizing conditions of the driving circuits associated with respective status data.

It is understood from the above embodiment that the image-data transmission path has a direction contrary to the status-data transmission path. The former indicates a shift of data from the sixth driving circuit toward the first driving circuit and away from the display controller, which is defined as a first direction, while the latter indicates a shift of data from the first driving circuit toward the sixth driving circuit and approaching the display controller, which is defined as a second direction.

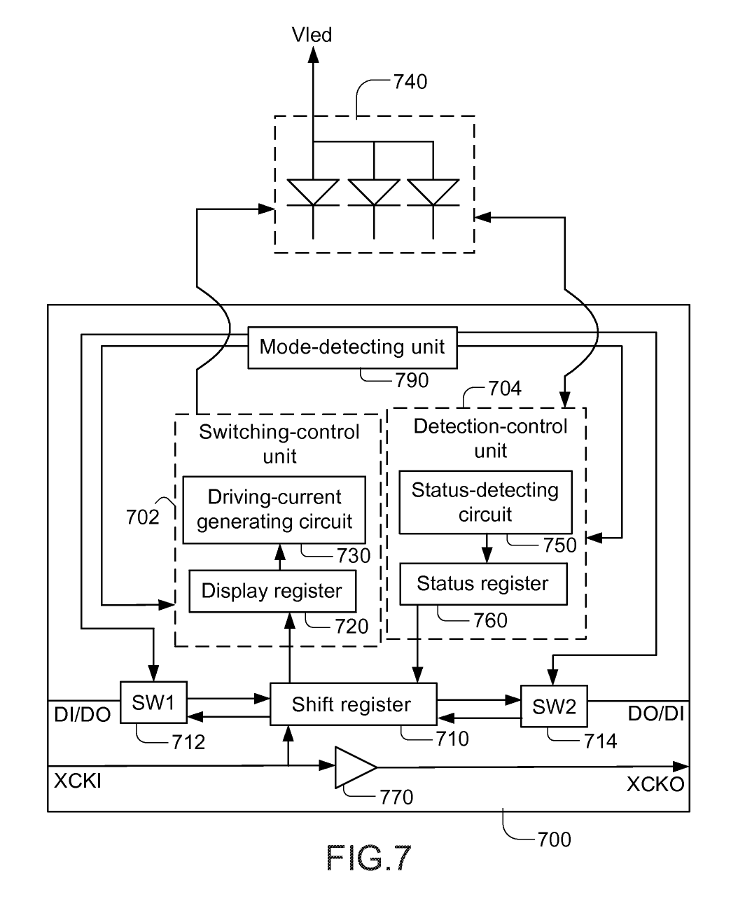

An embodiment of one of the driving circuits 51˜62, which is capable of implementing the contrary transmission paths in the displaying mode and detecting mode, respectively, is described hereinafter with reference to FIG. 7.

The driving circuit 700, for controlling the LED set 740, includes a shift register 710, a first switch circuit (SW1) 712, a second switch circuit (SW2) 714, a switching-control unit 702, a detection-control unit 704, a clock buffer 770, and a mode-detecting unit 790. The switch-controlling unit 702 includes a display register 720 and a driving-current generating circuit 730. The detection-control unit 704 includes a status register 760 and a status-detecting circuit 750. The LED set 740 includes a single LED or a plurality of LEDs emitting different colors of light, e.g. red, green and blue light. Which of the operation modes (display mode or detect mode) the display controller is in can be detected by the mode-detecting unit 790 in a variety of ways. For example, the information about the operation mode of the display controller can be directly passed to the mode-detecting unit 790 via a direct connection between the display controller and the mode-detecting unit 790; or the mode-detecting unit 790 can realize the operation mode of the display controller by detecting the waveform or frequency of the clock signal, which is optionally changed by the display controller.

The driving circuit 700 further includes a data-input/output terminal (DI/DO), a clock-input terminal (XCKI), a data-output/input terminal (DO/DI), and a clock-output terminal (XCKO). The data-input/output terminal (DI/DO) is used for receiving image data from preceding stage of driving circuit and the data-output/input terminal (DO/DI) is used for outputting image data to next stage of driving circuit in the displaying cycle; or, the data-output/input terminal (DO/DI) is used for receiving status data from next stage of driving circuit and the data-input/output terminal (DI/DO) is used for outputting status data to preceding stage of driving circuit in the detecting cycle.

Moreover, the data-input/output terminal (DI/DO) is electrically connected to the first switch circuit (SW1) 712; the first switch circuit (SW1) 712 is electrically connected to the shift register 710; the shift register 710 is electrically connected to the second switch circuit (SW2) 714; and the second switch circuit (SW2) 714 is electrically connected to the data-output/input terminal (DO/DI). Under this architecture, the data-transmission direction in the driving circuit 700 is controlled by the first switch circuit (SW1) 712 and the second switch circuit (SW2) 714, which are controlled by the mode-detecting unit 790 based on the desired operation mode. The shift register 710 is used for temporarily storing the image data or status data.

When the mode-detecting unit 790 detects that the display controller is in the displaying mode, the switching-control unit 702 is enabled by the mode-detecting unit 490 so that what the shift register 410 receives is the image data. Meanwhile, the first switch circuit (SW1) 712 and the second switch circuit (SW2) 714 are controller to transmit the image data in the first direction. The image data is then transmitted to the display register 720, and in response, a corresponding driving current is generated by the driving current generating circuit 730, and outputted to the LED set 740 to control the color and brightness of the LED set 740.

On the other hand, when the mode-detecting unit 790 detects that the display controller is in the detecting mode, the detection-control unit 704 is enabled by the mode-detecting unit 790 so that what is received by the shift register 410 is the status data. Meanwhile, the first switch circuit (SW1) 712 and the second switch circuit (SW2) 714 are controller to transmit the image data in the second direction. The status data is generated by the status-detecting circuit 750 in response to open-circuit and/or short-circuit detection of the LED set 740, temperature and/or error detection of the driving circuit 700, etc. The status data is stored in the status register 760 and then transmitted to the shift register 710. With the clock signal, the status data is further transmitted to the data-output/input terminal (DO/DI) and received by the display controller. According to the status data, the operation conditions of the LED set 740 and the driving circuit 700 can be realized by the display controller.

It is understood from the above descriptions, by differentiating the data transmission paths through the driving circuits in the display mode and the detecting mode, respectively, an external cable for connecting the driving circuits with the display controller to form a loop can be omitted. Accordingly, signal delay can be ameliorated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A LED display system, comprising:
a display controller comprising an output/input port;
a plurality of driving circuits coupled in series, wherein a first one of the driving circuits is coupled to the output/input port; and
a plurality of LED sets respectively coupled to the plurality of driving circuits;
wherein a plurality of image data, outputted from the display controller, are shifted to the plurality of driving circuits, respectively, in a first direction through the first one of the driving circuits when the display controller is in a displaying mode; and a plurality of status data, respectively generated by the plurality of driving circuits, are shifted to the display controller in a second direction through the first one of the driving circuits when the display controller is in a detecting mode.

2. The LED display system according to claim 1 wherein the output/input port comprises a data-output/input terminal and a clock-output terminal.

3. The LED display system according to claim 1 wherein one of the driving circuits comprises:
a data-input/output terminal;
a first switch circuit coupled to the data-input/output terminal;
a shift register coupled to the first switch circuit;
a second switch circuit coupled to the shift register;
a data-output/input terminal connected to the second switch circuit;
a switching-control unit, coupled to the shift register, from which a driving current is outputted to a corresponding one of the plurality of LED sets according to a corresponding one of the plurality of image data, wherein the corresponding one of the plurality of image data is temporarily stored in the shift register and then transmitted to the switching-control unit in the displaying mode;
a detection-control unit, coupled to the shift register, from which a corresponding one of the plurality of status data is outputted to be temporarily stored in the shift register in the detecting mode; and
a mode-detecting unit coupled to the first switch circuit and the second switch circuit for determining an operation mode of the display controller to be the displaying mode or the detecting mode, and controlling the switching-control unit, the detection-control unit, the first switch circuit and the second switch circuit based on the operation mode.

4. The LED display system according to claim 3 wherein the one of the driving circuits further comprises:
a clock-input terminal through which a clock signal is inputted;
a clock-output terminal through which the clock signal is outputted; and
a clock buffer coupled to the clock-input terminal, the clock-output terminal and the shift register for buffering the clock signal;
wherein the image data and the status data are shifted via the shift register in response to the clock signal.

5. The LED display system according to claim 3 wherein when the display controller is in the displaying mode, the first switch circuit and the second circuit are controlled by the mode-detecting unit to transmit the image data in the first direction from the first switch circuit to the second switch circuit via the shift register.

6. The LED display system according to claim 3 wherein when the display controller is in the detecting mode, the first switch circuit and the second circuit are controlled by the mode-detecting unit to transmit the status data in the second direction from the second switch circuit to the first switch circuit via the shift register.

7. The LED display system according to claim 3 wherein the switching-control unit comprises:
a display register, coupled to the shift register, for temporarily storing the corresponding one of the plurality of image data inputted from the shift register; and
a driving-current generating circuit, coupled to the display register, for generating the driving current to be outputted to the corresponding one of the plurality of LED sets.

8. The LED display system according to claim 3 wherein the detection-control unit comprises:
a status-detecting circuit for performing a detecting operation and generating the corresponding one of the plurality of status data; and
a status register, coupled to the status-detecting circuit and the shift register for temporarily storing and then transmitting the corresponding one of the plurality of status data to the shift register.

9. A data-transmission control method of a LED display system, the LED display system including a display controller, a plurality of LED sets and a plurality of driving circuits coupled in series, respectively coupled to the plurality of LED sets, and further coupled to the display controller via a first one of the driving circuits, the data-transmission control method comprising steps of:
outputting a plurality of image data from the display controller and respectively shifting the plurality of image data to the plurality of driving circuits in a first direction through the first one of the driving circuits when the display controller is in a displaying mode; and
respectively outputting a plurality of status data from the plurality of driving circuits and shifting the plurality of status data to the display controller in a second direction through the first one of the driving circuits when the display controller is in a detecting mode.

10. The method according to claim 9 further comprising a step of:
driving the plurality of LED sets according to the plurality of image data transmitted to the plurality of driving circuits, respectively.

11. A driving circuit for use in a LED display system to drive a LED set coupled thereto, comprising:
a data-input/output terminal;
a first switch circuit coupled to the data-input/output terminal;
a shift register coupled to the first switch circuit;
a second switch circuit coupled to the shift register;
a data-output/input terminal connected to the second switch circuit;
a switching-control unit, coupled to the shift register, from which a driving current is outputted to the LED set according to an image data temporarily stored in the shift register when the display controller is in a displaying mode;
a detection-control unit, coupled to the shift register, from which a status data is outputted to be temporarily stored in the shift register when the display controller is in a detecting mode; and
a mode-detecting unit coupled to the first switch circuit and the second switch circuit for determining an operation mode of the display controller to be the displaying mode or the detecting mode, and controlling the switching-control unit, the detection-control unit, the first switch circuit and the second switch circuit based on the operation mode;
wherein when the display controller is in the displaying mode, the first switch circuit and the second circuit are controlled to transmit the image data through the first switch circuit and then the shift register, and when the display controller is in the connecting mode, the first switch circuit and the second circuit are controlled to transmit the status data through the shift register and then the first switch circuit.

12. The driving circuit according to claim 11 further comprising:
a clock-input terminal through which a clock signal is inputted;
a clock-output terminal through which the clock signal is outputted; and
a clock buffer coupled to the clock-input terminal, the clock-output terminal and the shift register for buffering the clock signal;
wherein the image data and the status data are shifted via the shift register in response to the clock signal.

13. The driving circuit according to claim 11 wherein the switching-control unit comprises:
a display register, coupled to the shift register, for temporarily storing the image data inputted from the shift register; and
a driving-current generating circuit, coupled to the display register, for generating the driving current to be outputted to the LED set.

14. The driving circuit according to claim 11 wherein the detection-control unit comprises:
a status-detecting circuit for performing a detecting operation and generating the status data; and
a status register, coupled to the status-detecting circuit and the shift register for temporarily storing and then transmitting the status data to the shift register.
